(19) United States
(12) Patent Application Publication
(10) Pub. No.: US 2014/0149473 A1
(43) Pub. Date: May 29, 2014

(54) FILE SYSTEM FOR FLASH MEMORY

(71) Applicant: RESEARCH & BUSINESS FOUNDATION SUNGKYUNKWAN UNIVERSITY, Suwon-si (KR)

(72) Inventors: Jin-soo KIM, Seoul (KR); Je-min KIM, Seoul (KR); Hyeong-jun KIM, Suwon-si (KR)

(73) Assignee: RESEARCH & BUSINESS FOUNDATION SUNGKYUNKWAN UNIVERSITY, Suwon-si (KR)

(21) Appl. No.: 14/090,214

(22) Filed: Nov. 26, 2013

(30) Foreign Application Priority Data
Nov. 29, 2012 (KR) 10-2012-0137201

(51) Int. Cl. G06F 17/30

(52) U.S. Cl. CPC G06F 17/30091
USPC 707/824

(57) ABSTRACT

A memory system includes a memory including a predetermined information storage space, a general data block in which pieces of general data are stored in the information storage space of the memory, and a metadata block in which metadata related to the pieces of general data is stored in the information storage space of the memory. The metadata corresponding to at least one piece of general data is grouped and stored in the metadata block.

### CROSS-REFERENCE TO RELATED APPLICATION

This application claims priority to and the benefit of Korean Patent Application No. 10-2012-0137201, filed on Nov. 29, 2012, the disclosure of which is incorporated herein by reference in its entirety.

### BACKGROUND

1. Field

The following description relates to a file system for a flash memory.

2. Discussion of Related Art

A file system refers to a concept of storing, withdrawing, and updating a set of files, and includes a concept of organizing a plurality of files in a byte stream. Generally, a file system manages access to data or metadata, and an available space of a storage medium. Accordingly, one of the main functions of the file system is to reliably manage the metadata.

A fourth extended file system (EXT4 file system) among the file systems is mainly used in Linux, which maintains and manages an individual file having a size of 16 gigabytes (GB) to 16 terabytes (TB) in a file system, and maintains and manages a file system having a size of one exabyte (EB). There are a super block, a block bitmap, an Mode bitmap, and an Mode table in main metadata of the EXT4 file system. It is important to reliably manage the metadata, as described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a conventional EXT4 file system, general data and metadata corresponding to the general data are divided into respective blocks to be written and managed in blocks. A metadata block includes a small amount of data, undergoes continual accessing and writing thereto. However, when a metadata block is stored in a memory system which operates in a multi-level cell (MLC) mode and continually accessed and written, degradation in performance occurs since the metadata block is backup in a paired page coupled due to a reliability issue.

In addition, since two bits are stored in a memory cell in the MLC mode, the time at which a cell reaches the end of its lifetime due to frequent accessing and writing of data (so called “wear-out” state) is earlier in the MLC mode than in a single-level cell (SLC) mode. That is, there is a problem in that a usable life of a memory that operates in the MLC mode is shorter than that of a memory that operates in the SLC mode.

Accordingly, when metadata of a file system is stored in a cell that operates in the MLC mode, the consequential degradation in performance and shortened life significantly affect reliability of the whole memory.

The present disclosure relates to a file system with higher reliability compared to a conventional file system.

In addition, the present disclosure relates to a file system with a longer life compared to a conventional file system.

According to a general aspect, a memory system includes a memory having a predetermined information storage space, a general data block in which pieces of general data are stored in the information storage space of the memory, and a metadata block in which metadata related to the pieces of general data is stored in the information storage space of the memory. The metadata corresponding to at least one piece of general data is grouped and stored in the metadata block.

According to another general aspect, a memory system includes a memory including a predetermined information storage space, a general data block in which pieces of general data are stored in the information storage space of the memory, and a journaling block journaling the pieces of general data. Journaling data corresponding to the pieces of general data is grouped and stored in the journaling block.

### BRIEF DESCRIPTION OF THE DRAWINGS

FIGS. 1 and 3 are block diagrams schematically showing memories according to exemplary embodiments of the present disclosure; and

FIG. 2 is a diagram for schematically describing operation of a multi-level cell.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

All terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a memory system according to an exemplary embodiment of the present disclosure will be described with reference to accompanying drawings. The memory system according to an exemplary embodiment of the present disclosure includes a memory having a predetermined information storage space, a general data block in which pieces of general data are stored in the information storage space of the memory, and a metadata block in which metadata related to the pieces of general data is stored in the information storage space of the memory, wherein the metadata corresponding to at least one piece of general data is grouped and stored in the metadata block. A memory system according to another exemplary embodiment of the present disclosure includes a memory having a predetermined information storage space, a general data block in which pieces of general data are stored in the information storage space of the memory, and a metadata block in which metadata related to the pieces of general data is stored in the information storage space of the memory, wherein the memory is a NAND-type flash memory and the metadata block is stored in a single-level cell mode.

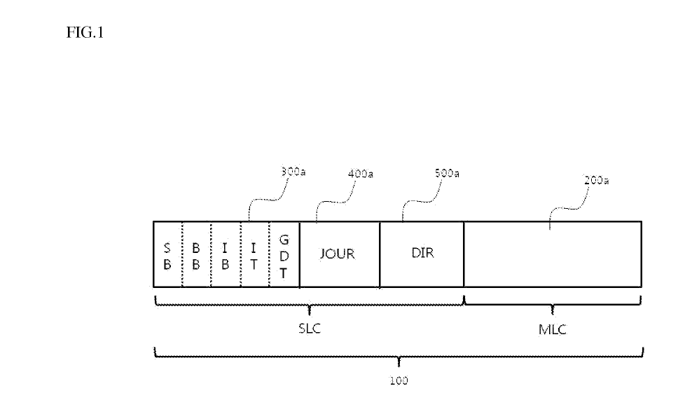

FIG. 1 is a block diagram schematically showing a memory system according to an exemplary embodiment of the present disclosure. In FIG. 1, a storage space 100 of a memory is expressed as a rectangular space. Referring to FIG. 1, the memory system according to the exemplary embodiment of the present disclosure includes a memory having a predetermined information storage space 100. In some embodiments, the memory is a NAND-type flash memory. A flash memory is a kind of non-volatile memory. The flash memory includes a floating gate transistor called a “cell,” stores information by injecting charges to a floating gate, and reads information according to variation in a threshold voltage by the injected charges.

The memory includes a general data block 200a in which general data is stored. As an exemplary embodiment, the general data refers to data excluding metadata to be described later, which may be files or programs a user stored in the memory, an execution file used in an operating system the user uses, or information files. However, those are examples for describing the general data according to an exemplary embodiment of the present disclosure, and the present disclosure should not be construed as limited to the embodiments set forth herein.

The memory according to an exemplary embodiment of the present disclosure includes a metadata block 300 in which metadata related to pieces of the general data is stored in an information storage space of the memory. As an exemplary embodiment, a metadata block 300a is grouped and stored in the memory, as shown in FIG. 1. For example, in the EXT4 file system, each of metadata blocks 300a and 300b includes a super block SB, a block bitmap BB, an Mode bitmap IB, an Mode table IT, and a group descriptor table GDT. The super block SB serves to store file system information of the memory, such as the total number of blocks, the total number of Modes, the number of available blocks, the number of available Modes, etc. Since the super block SB is related to an overall status of the memory, only one per memory is stored and managed. The block bitmap BB traces use of data blocks in a block group. The Mode includes data on the size, permission, and ownership of a file or a directory, or a disk location of the file or directory. The Mode table IT is a set of the Modes, and the Mode bitmap IB writes an entry of the Mode table IT that is being used. In the EXT4 file system, block groups have respective descriptors, and the group descriptor table GDT stores information by which each block group is managed associated with the respective descriptors.

When a physical error occurs in a memory area at which the metadata including the super block SB, the block bitmap BB, the Mode bitmap IB, the Mode table IT, and the group descriptor table GDT which perform the above-described functions is stored, problems, such as not being able to access general data in a general data block corresponding to the metadata, occur to affect operation of the memory.

In an exemplary embodiment of the present disclosure, the metadata including the super block SB, block bitmap BB, Mode bitmap IB, Mode table IT, and group descriptor table GDT corresponding to pieces of the general data stored in the memory is grouped and stored in the metadata block 300a. Then, the memory in which the metadata block 300a is stored operates in a single-level cell mode.

Referring to FIG. 1, in an exemplary embodiment of the present disclosure, a memory area in which a journaling block 400a and a directory block 500 are stored with the metadata block 300a operates in a single-level cell mode. The journaling block 400a groups and stores journaling data, and the directory block 500a groups and stores directory information. A detailed description thereof will be provided in the following exemplary embodiment.

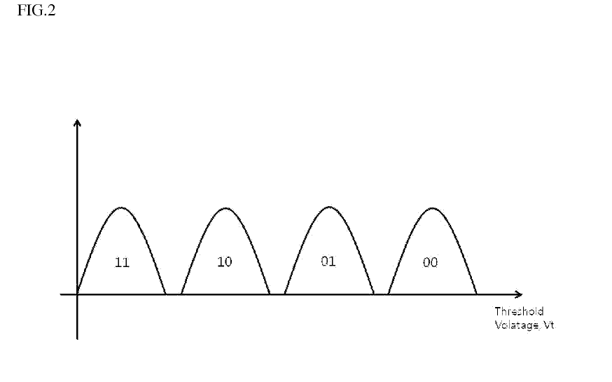

A flash memory stores information using variation in a threshold voltage by charges injected to a floating gate, as described above. Referring to FIG. 2, the injected charges may be controlled by adjusting voltage applied to a memory cell. As shown in FIG. 2, the flash memory stores two binary bits of information corresponding “11,” “10,” “01,” and “00” by adjusting the voltage. A unit flash memory cell having such a configuration is called a multi-level cell (MLC). On the other hand, a unit flash memory cell that stores a single binary bit is called a single-level cell (SLC). Operating modes of the MLC and the SLC can be switched.

The MLC can store about twice the amount of information as compared to the SLC, in the same area, and therefore has advantages in terms of information density. However, since the number of access to information stored in a memory cell of the MLC, or the number of writing information in the memory cell of the MLC is smaller than that of the SLC, the life expectancy of the MLC is shorter than that of the SLC. Further, when metadata is stored in an area that operates in a multi-level cell mode, a life in which the memory cell reliably operates may be reduced since the number of access to metadata or information-updates on metadata by a file system is greater compared with general data. To solve the problem, the metadata block 300a according to an exemplary embodiment of the present disclosure is stored in a cell that operates in a single-level cell mode. In addition, the metadata related to pieces of general data is stored in a metadata block, and then an area corresponding to the metadata block is operated in a single-level cell mode. Accordingly, reliability and stability in operation of the memory can be improved.

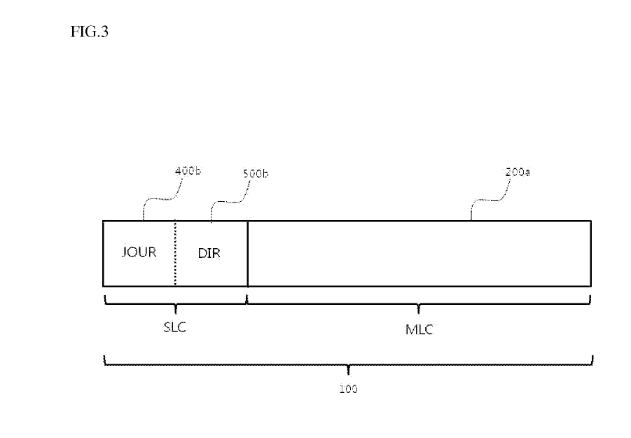

Another exemplary embodiment of the present disclosure will be described with reference to FIG. 3. Duplicate description of the above-described exemplary embodiment will be omitted to simplify and clarify the description. FIG. 3 is a block diagram schematically showing a memory system according to an exemplary embodiment of the present disclosure. Referring to FIG. 3, a storage space 100 of a memory is expressed as a rectangular space.

A general data block 200b storing general data is located in the memory. In some embodiments, the general data block 200b is stored in an area that operates in a multi-level cell mode in order to improve the information density.

Data made by journaling metadata related to pieces of general data is grouped and stored in a journaling block (JOUR) 400b. Here, the journaling refers to writing metadata and/or general data on a journaling area before writing them on a general data block, and then writing them on the general data block in a file system. Accordingly, the data made by journaling metadata in the exemplary embodiment of the present disclosure, refers to data being written on the journaling area before writing the general data on the general data block. According to the method of journaling in the exemplary embodiment of the present disclosure, file system errors generated by abnormal shut-down due to a system failure or an electric power interruption can be minimized In the related arts, the journaling data is distributed in a memory area, and the journaling data is stored in the memory area that operates in a multi-level cell mode. Accordingly, there is a problem in that reliability of the journaling data as well as the metadata decrease sharply, as the life of a memory approaches to an end.

According to the exemplary embodiment of the present disclosure, since the journaling data is grouped and stored in a memory area that operates in a single-level cell mode, a file system and a memory that more reliably operate can be implemented.

In an exemplary embodiment of the present disclosure, the journaling data may be grouped with the metadata, and stored in the memory area that operates in a single-level cell mode, as the above-described exemplary embodiment.

In an exemplary embodiment of the present disclosure, the memory area includes a directory block (DIR) 500b in which directory information is grouped and stored. In an EXT 4 file system, a directory has a single Mode the same as a single file, and stores an Mode link associated with the file stored thereinside. The directory information is grouped and stored in an area that operates in a single-level cell mode.

According to an exemplary embodiment of the present disclosure, since the directory information is grouped and stored in a memory area that operates in a single-level cell mode, the directory information can be stably stored, and a file system and a memory that more reliably operate can be implemented.

In order to group the metadata including the super block SB, the block bitmap BB, the Mode bitmap IB, the Mode table IT, and the group descriptor table GDT, the journaling data, and the directory information into blocks and store them in a memory that operates in a single-level cell mode, a file system 900 needs to instruct a memory system in the range of a memory area to operate in the single-level cell mode. As an exemplary embodiment, the file system and the memory system according to an exemplary embodiment of the present disclosure transmit/receive data to/from each other through an interface. Accordingly, the file system transmits information about the memory area that is to operate in a single-level cell mode to the memory system according to an exemplary embodiment of the present disclosure, and the memory system separately manages an area that operates in a single-level cell mode, and an area that operates in a multi-level cell mode, based on the received information. As another exemplary embodiment, the file system stores information about the memory area that is to operate in a single-level cell mode in a specific area of the memory system according to the exemplary embodiment of the present disclosure, and the memory system separately manages an area that operates in a single-level cell mode, and an area that operates in a multi-level cell mode, based on the information. Accordingly, the sizes of the area that operates in a single-level cell mode and the area that operates in a multi-level cell mode may dynamically change.

According to exemplary embodiments of the present disclosure, when general data is added in a memory, or general data stored in the memory is deleted, metadata corresponding thereto needs to be modified. In this case, the sizes of metadata blocks 300a and 300b in which metadata is stored, is controlled by the file system, and the single-level cell mode is converted to the multi-level cell mode, or vice versa, according to the amount of controlled size.

In a memory system according to the exemplary embodiments of the present disclosure, since a metadata block requiring frequent access and frequent updating of information is stored in a single-level cell mode in a memory, the access speed and the information updating speed are improved, and thereby performance of operation of the memory is improved.

In a memory system according to the exemplary embodiments of the present disclosure, since a metadata block requiring frequent access and frequent updating of information is stored in a single-level cell mode in a memory, life increases compared to when it is stored in a multi-level cell mode, and thereby life of the memory increases.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A memory system, comprising:
a memory including a predetermined information storage space;
a general data block in which pieces of general data are stored in the information storage space of the memory; and
a metadata block in which metadata related to the pieces of general data is stored in the information storage space of the memory,
wherein the metadata corresponding to at least one piece of general data is grouped and stored in the metadata block.

2. The memory system of claim 1, wherein the memory is a flash memory.

3. The memory system of claim 1, wherein the metadata block is stored in the memory in a single-level cell mode.

4. The memory system of claim 1, wherein the general data block is stored in the memory in a multi-level cell mode.

5. The memory system of claim 1, wherein the metadata includes a super block, a block bitmap, an Mode bitmap, an Mode table, and a group descriptor table.

6. The memory system of claim 1, wherein the size of the metadata block dynamically changes.

7. The memory system of claim 1, wherein the size of the general data block dynamically changes.

8. The memory system of claim 3, wherein at least one of a journaling block and a directory block is stored in the memory in the single-level cell mode.

9. A memory system, comprising:
a memory including a predetermined information storage space;
a general data block in which pieces of general data are stored in the information storage space of the memory; and
a journaling block journaling the pieces of general data,
wherein journaling data corresponding to the pieces of general data is grouped and stored in the journaling block.

10. The memory system of claim 9, wherein the general data block is stored in the memory in a multi-level cell mode.

11. The memory system of claim 9, wherein the journaling block is stored in the memory in a single-cell mode.

12. The memory system of claim 9, further comprising a directory block in which directory information is grouped and stored.

13. The memory system of claim 12, wherein the directory block is stored in the memory in a single-level cell mode.

14. The memory system of claim 9, wherein the size of the journal block dynamically changes.

15. The memory system of claim 9, wherein the size of the general data block dynamically changes.

16. The memory system of claim 9, wherein the journaling data is one or more including metadata corresponding to the general data among the general data and the metadata corresponding to the general data.
